(19) United States
(12) Patent Application Publication
(10) Pub. No.: US 2026/0292095 A1
(43) Pub. Date: Sep. 24, 2026

(54) OBSTACLE AVOIDANCE PROJECTION METHOD AND PROJECTION SYSTEM

(71) Applicant: Coretronic Corporation, Hsin-Chu (TW)

(72) Inventors: Shu-Hao Hsu, Hsin-Chu (TW); Wei-Tai Ko, Hsin-Chu (TW); Hsing-Yu Chen, Hsin-Chu (TW)

(73) Assignee: Coretronic Corporation, Hsin-Chu (TW)

(21) Appl. No.: 19/570,090

(22) Filed: Mar. 17, 2026

Related U.S. Application Data
(60) Provisional application No. 63/775,323, filed on Mar. 21, 2025.

(30) Foreign Application Priority Data
Jun. 18, 2025 (CN) 202510814712.5

(51) Int. Cl. H04N 5/74; G06T 7/13; G06T 7/80; G06V 10/141; G06V 10/74

(52) U.S. Cl. CPC H04N 5/74; G06T 7/13; G06T 7/80; G06V 10/141; G06V 10/761

(57) ABSTRACT

Provided are an obstacle avoidance projection method and a projection system. The obstacle avoidance projection method includes: capturing a reference image, in which the reference image includes a calibration image; receiving reference image information and obtaining calibration image information; calculating multiple matching image feature point pairs based on the reference image information and the calibration image information; based on the matching image feature point pairs, performing mapping transformation on region information corresponding to the calibration image in the reference image information to generate obstacle avoidance image information; performing edge detection operation on the obstacle avoidance image information to generate edge detection result image information, and calibrating partial information corresponding to a calibration pattern in the edge detection result image information; and performing region determination operation on the corrected edge detection result image information to set a maximum obstacle-free region in the edge detection result image.

### CROSS-REFERENCE TO RELATED APPLICATION

This application claims the priority benefits of U.S. provisional application Ser. No. 63/775,323, filed on Mar. 21, 2025, and China application serial no. 202510814712.5, filed on Jun. 18, 2025. The entirety of each of the above-mentioned patent applications is hereby incorporated by reference herein and made a part of this specification.

### BACKGROUND

### Technical Field

The disclosure relates to a projection calibration technique, and particularly relates to an obstacle avoidance projection method and a projection system.

### Related Art

With the popularization of multimedia applications, projectors have been widely applied in various scenarios such as education, business presentations, home entertainment, and outdoor displays. Conventional projectors usually need to be used with projection screens or flat wall surfaces to obtain ideal display effects. However, when projectors operate in non-ideal environments, such as cramped spaces, spaces with numerous objects, or asymmetric structural spaces, the projected images are easily blocked or interfered with by obstacles in the environment, resulting in incomplete image presentation and thus affecting user experience.

Most projectors in the related art are not equipped with automatic obstacle avoidance projection function, especially in the absence of assistance from image sensing/capturing devices (such as camera modules), when obstacles appear within the projection region of the projector and cause the projected image to be partially blocked by the obstacles, it is necessary to rely on manual methods to adjust the placement position, angle, or projection region dimension of the projector, so that the projected image is not projected onto the obstacles, thereby ensuring subsequent viewing experience. Such manual adjustment methods are not only time-consuming and labor-intensive, but also require users to have a certain degree of understanding of projection principles, which creates a usage burden for general consumers.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In view of above, the disclosure provides an obstacle avoidance projection method and a projection system, which may be used to solve the above technical problems.

Other purposes and advantages of the disclosure may be further understood from the technical features disclosed by the disclosure.

To achieve one or part or all of the above purposes or other purposes, one embodiment of the disclosure provides an obstacle avoidance projection method executed by a mobile device, in which the mobile device includes a camera unit and a processing unit coupled to the camera unit, and the mobile device is communicatively connected to a projection device. The obstacle avoidance projection method includes the following. A first reference image is captured by the camera unit, in which the first reference image includes a first calibration image projected by the projection device onto a projection surface according to first calibration image information, and the first calibration image includes a calibration pattern. Steps as follows are executed by the processing unit. First reference image information corresponding to the first reference image from the camera unit is received, and first calibration image information corresponding to the first calibration image is obtained. Multiple matching image feature point pairs are calculated based on the first reference image information and the first calibration image information. Based on the matching image feature point pairs, mapping transformation is performed on region information corresponding to the first calibration image in the first reference image information to generate obstacle avoidance image information. Edge detection operation is performed on the obstacle avoidance image information to generate edge detection result image information corresponding to an edge detection result image, and partial information corresponding to the calibration pattern in the edge detection result image information is calibrated. Region determination operation is performed on the corrected edge detection result image information to set a maximum obstacle-free region in the edge detection result image. Also, the multiple projection range coordinates are generated based on the maximum obstacle-free region, and the projection range coordinates are sent to the projection device.

To achieve one or part or all of the above purposes or other purposes, one embodiment of the disclosure provides an obstacle avoidance projection method executed by a mobile device, in which the mobile device includes a camera unit and a processing unit coupled to the camera unit, and the mobile device is communicatively connected to a projection device. The obstacle avoidance projection method includes the following. A first reference image is captured by the camera unit, in which the first reference image includes a first calibration image projected by the projection device onto a projection surface, and the first calibration image includes a calibration pattern. A second reference image is captured by the camera unit, in which the second reference image includes a second calibration image projected by the projection device onto the projection surface, and the second calibration image is a background color image. Also, steps as follows are executed by the processing unit. The first reference image information corresponding to the first reference image and second reference image information corresponding to the second reference image from the camera unit are received, and first calibration image information corresponding to the first calibration image is obtained. Multiple matching image feature point pairs are calculated based on the first reference image information and the first calibration image information. Based on the matching image feature point pairs, mapping transformation is performed on region information corresponding to the first calibration image in the second reference image information to generate obstacle avoidance image information. Edge detection operation is performed on the obstacle avoidance image information to generate edge detection result image information corresponding to an edge detection result image. Region determination operation is performed on the edge detection result image information to set a maximum obstacle-free region in the edge detection result image. Also, multiple projection range coordinates are generated based on the maximum obstacle-free region, and the projection range coordinates are sent to the projection device.

To achieve one or part or all of the above purposes or other purposes, one embodiment of the disclosure provides a projection system including a projection device and a mobile device. The projection device is configured to project a first calibration image onto a projection surface according to first calibration image information, and the first calibration image includes a calibration pattern. The mobile device is communicatively connected to the projection device and is configured to execute the obstacle avoidance projection method as described above. The projection device sets a projection range according to multiple projection range coordinates.

To achieve one or part or all of the above purposes or other purposes, one embodiment of the disclosure provides a projection system including a projection device and a mobile device. The projection device is configured to project a first calibration image onto a projection surface according to first calibration image information, and project a second calibration image onto the projection surface according to second calibration image information, in which the first calibration image includes a calibration pattern, and the second calibration image is a background color image. The mobile device is communicatively connected to the projection device and is configured to execute the obstacle avoidance projection method as described above. The projection device sets a projection range according to multiple projection range coordinates.

In summary, the obstacle avoidance projection method and the projection system of the embodiments of the disclosure may achieve automatic obstacle identification of the projection device through the mobile device, and provide a convenient operation interface through the mobile device application program, enabling the projection system to automatically perform calibration and projection region adjustment without requiring users to manually adjust or set the projection device. The automatic obstacle avoidance mechanism described in the disclosure may quickly complete the setting of the maximum available projection range, significantly simplifying the setup process, and improving overall accuracy.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of a projection system of the disclosure.

FIG. 2 is a flowchart of an obstacle avoidance projection method of a first embodiment of the disclosure.

FIG. 3A is a schematic diagram of a first calibration image of the first embodiment of the disclosure.

FIG. 3B is a schematic diagram of a mobile device preview screen of the first embodiment of the disclosure.

FIG. 4A is an original first reference image captured by a camera unit of a mobile device in the first embodiment of the disclosure.

FIG. 4B is a first reference image after preprocessing in the first embodiment of the disclosure.

FIG. 4C is a schematic diagram of matching between the first calibration image and the first reference image for image feature matching in the first embodiment of the disclosure.

FIG. 4D is an image region corresponding to the first calibration image in the first reference image after mapping transformation in the first embodiment of the disclosure.

FIG. 4E is an obstacle avoidance image generated by applying another mapping transformation to the image region in FIG. 4D.

FIG. 4F is an edge detection result image generated after performing edge detection operation on the obstacle avoidance image in FIG. 4E.

FIG. 4G is the edge detection result image after applying region masking to the edge detection result image in FIG. 4E.

FIG. 5A and FIG. 5B are flowcharts of region determination operation performed on edge detection result image information in the first embodiment of the disclosure.

FIG. 6A and FIG. 6B are application schematic diagrams of the flowchart of region determination operation in the first embodiment of the disclosure.

FIG. 7A and FIG. 7B are another application schematic diagram of the flowcharts of region determination operation in the first embodiment of the disclosure.

FIG. 8 is a schematic diagram of a maximum obstacle-free region in the first embodiment of the disclosure.

FIG. 9 is a flowchart of the obstacle avoidance projection method in a second embodiment of the disclosure.

FIG. 10A is the original first reference image captured by the camera unit of the mobile device in the second embodiment of the disclosure.

FIG. 10B is the preprocessed first reference image in the second embodiment of the disclosure.

FIG. 11A is an original second reference image captured by the camera unit of the mobile device in the second embodiment of the disclosure.

FIG. 11B is a preprocessed second reference image in the second embodiment of the disclosure.

FIG. 11C is the image region corresponding to the first calibration image in the second reference image after mapping transformation in the second embodiment of the disclosure.

FIG. 11D is the obstacle avoidance image generated by applying another mapping transformation to the image region in FIG. 11C.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The aforementioned and other technical contents, features and effects of the disclosure will be clearly presented in the following detailed description of preferred embodiments with reference to the accompanying drawings. The directional terms mentioned in the following embodiments, such as up, down, left, right, front, or back, are merely references to the directions of the accompanying drawings. Therefore, the directional terms used are for illustration and not for limiting the disclosure.

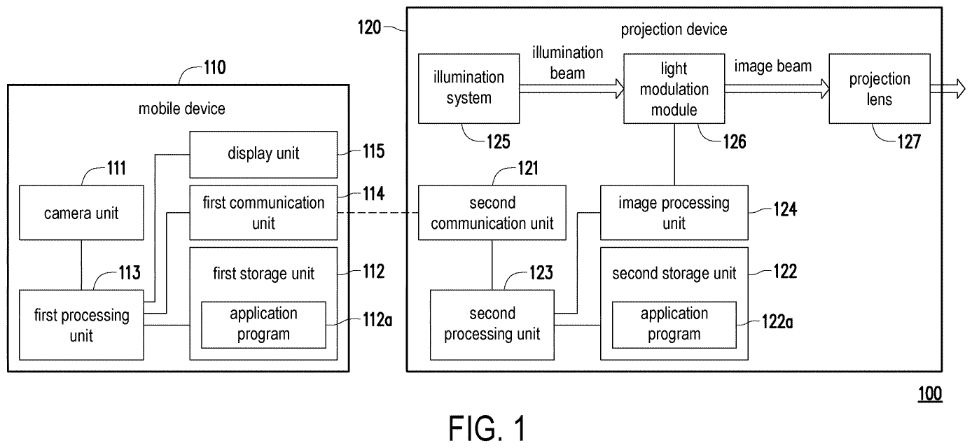

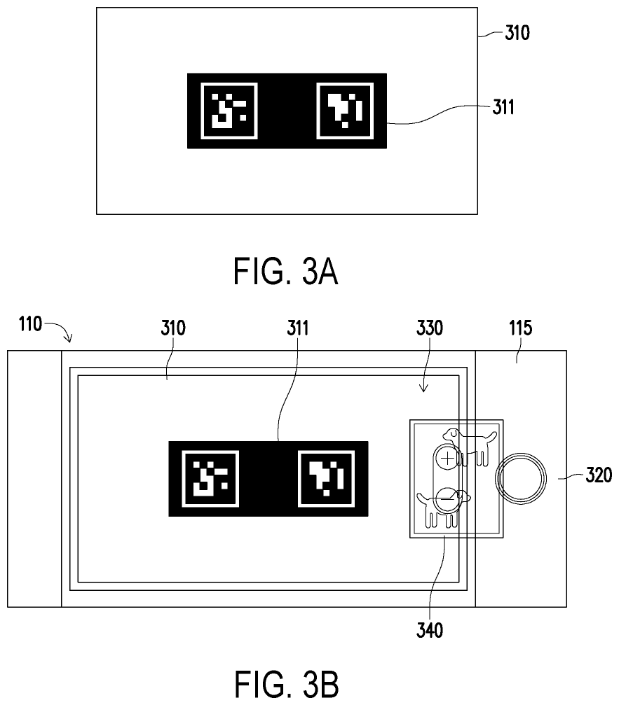

Please refer to FIG. 1, which is a block diagram of a projection system according to a first embodiment of the disclosure. FIG. 3A is a schematic diagram of a first calibration image of the first embodiment of the disclosure. FIG. 3B is a schematic diagram of a mobile device preview screen of the first embodiment of the disclosure. In FIG. 1, a projection system 100 includes a mobile device 110 and a projection device 120. The mobile device 110 and the projection device 120 are communicatively connected through wired/wireless manners, and cooperatively execute the projection obstacle avoidance function to automatically adjust the projection range.

In First embodiment, the mobile device 110 includes a camera unit 111 and a first processing unit 113 electrically coupled to the camera unit 111. The camera unit 111 is configured to capture a first reference image 330 (shown in FIG. 3B), in which the first reference image includes a first calibration image 310 (shown in FIGS. 3A and 3B) projected by the projection device 120 onto a projection surface according to first calibration image information, and the first calibration image includes a calibration pattern. The first processing unit 113 of the mobile device 110 is configured to execute the following steps. First reference image information corresponding to a first reference image 330 from the camera unit 111 is received, and the first calibration image information corresponding to the first calibration image 310 is obtained. Multiple matching image features are calculated and obtained based on the first reference image information and the first calibration image information. Based on the matching image feature points, mapping transformation is performed on region information corresponding to the first calibration image in the first reference image information to generate obstacle avoidance image information. Edge detection operation is performed on the obstacle avoidance image information to generate edge detection result image information corresponding to an edge detection result image, and partial information corresponding to the calibration pattern in the edge detection result image information is calibrated. Region determination operation is performed on the corrected edge detection result image information to set a maximum obstacle-free region in the edge detection result image. Also, multiple projection range coordinates are generated based on the maximum obstacle-free region, and the projection range coordinates are sent to the projection device 120.

In the first embodiment, the mobile device 110 may further include a first storage unit 112, a first communication unit 114, and a display unit 115, in which the first processing unit 113 is electrically coupled to the first storage unit 112, the first communication unit 114, and the display unit 115.

The projection device 120 includes a second communication unit 121, a second storage unit 122, a second processing unit 123, an image processing unit 124, an illumination system 125, a light modulation module 126, and a projection lens 127, in which the second processing unit 123 is electrically coupled to the second communication unit 121, the second storage unit 122, and the image processing unit 124. In addition, the light modulation module 126 is electrically coupled to the image processing unit 124, and is disposed on an optical path between the illumination system 125 and the projection lens 127.

The first storage unit 112 of the mobile device 110 stores an application program 112a and the first calibration image information of the first calibration image, in which when the first processing unit 113 of the mobile device 110 executes the application program 112a, it is configured to be used to manage and operate the projection device 120, exchange information with the projection device 120, and/or present a corresponding operation interface on the display unit 115, in which the operation interface may present, for example, identity information (such as brand name, model, serial number of the projection device 120) of the projection device 120.

In addition, the first calibration image is applied in the obstacle avoidance projection method proposed by the disclosure, and related details will be explained with subsequent embodiments.

In the embodiments of the disclosure, the mentioned “image information of a certain image” may generally refer to information related to the image that is captured, analyzed, or derived from the image, including but not limited to geometric information and content information. In one embodiment, the aforementioned geometric information may include information such as spatial position (for example, coordinates), dimension (for example, length/width, area), shape (for example, rectangle, circle), direction (for example, rotation angle) of patterns or specific targets in the image, or relative positional relationships with other objects. This type of information may be used to describe the spatial distribution characteristics of patterns or specific targets in the image, or used to calculate the correspondence relationship between the image and the physical environment. In addition, the aforementioned content information refers to pixel values (for example, brightness, color, grayscale value), texture features (for example, edge, corner point, pattern variation), pattern structure (for example, line distribution, block segmentation result) contained in the image. This type of information may be used to identify patterns, determine image quality, or extract specific regions for subsequent processing.

Based on this principle, the first calibration image information of the first calibration image may include, for example, geometric information and content information related to the first calibration image, but the disclosure is not limited thereto.

When the first processing unit 113 of the mobile device 110 executes the application program 112a, the first processing unit 113 controls the display unit 115 to display the operation interface of the application program 112a. The operation interface of the application program 112a displayed by the display unit 115 may present a list of all devices within the communication range of the first communication unit 114 of the mobile device 110. A user of the mobile device 110 may select the identity information of the projection device 120 in the list on the operation interface of the application program 112a, so that the mobile device 110 establishes a wired or wireless connection with the projection device 120.

In response to determining that the identity information of the projection device 120 is selected, the first processing unit 113 controls the first communication unit 114 to establish a connection with the projection device 120. In this case, the first communication unit 114 may, for example, establish a corresponding connection with the second communication unit 121 of the projection device 120 according to a supported communication protocol (such as Bluetooth,).

The operation interface of the application program 112a may provide an obstacle avoidance function option for activating the mobile device 110 and the projection device 120 to cooperatively execute the obstacle avoidance projection method proposed by the embodiments of the disclosure, and related details of this method will be explained with subsequent embodiments.

In one embodiment, in response to determining that the obstacle avoidance function option in the operation interface of the application program 112a is activated, the first processing unit 113 controls the first communication unit 114 to send an obstacle avoidance function activation instruction to the selected projection device 120 through the aforementioned connection.

Referring to FIG. 1 still, the second storage unit 122 of the projection device 120 is configured to store the application program 122a and the first calibration image information corresponding to the first calibration image. After the second communication unit 121 of the projection device 120 receives the obstacle avoidance function activation instruction from the mobile device 110, the second processing unit 123 may execute the application program 122a according to the obstacle avoidance function activation instruction. The first calibration image information stored by the second storage unit 122 of the projection device 120 is the same as the first calibration image information stored by the first storage unit 112 of the mobile device 110.

The illumination system 125 of the projection device 120 is configured to generate an illumination beam, and the image processing unit 124 of the projection device 120 receives the first calibration image information from the second processing unit 121, and controls the light modulation module 126, so that the light modulation module 126 converts the illumination beam into an image beam corresponding to the first calibration image based on the first calibration image information. The projection lens 127 of the projection device 120 is configured to project the image beam corresponding to the first calibration image toward a projection surface.

After the projection device 120 is powered on, the second processing unit 123 may execute image keystone calibration based on the device posture information of the projection device 120 to generate a plurality of calibrated projection corner coordinates, and the projection device 120 is configured to project the adjusted first calibration image according to the plurality of calibrated projection corner coordinates. In some embodiments, the device posture information of the projection device 120 may, for example, refer to related information describing the direction and tilt state of the projection device 120 in space, including but not limited to at least one posture angle among pitch, roll, and yaw. The device posture information may be used to represent the coordinates and/or rotation state of the projection device relative to a reference coordinate system (such as gravity direction or projection surface normal). In some embodiments, the device posture information may be obtained in real time through sensing modules (such as accelerometer, gyroscope, and/or ranging module) built into the projection device 120, but the disclosure is not limited thereto.

Next, the second processing unit 123 of the projection device 120 may control the second communication unit 121 to send the calibrated projection corner coordinates to the mobile device 110 as a basis for subsequently executing the obstacle avoidance projection method, but the disclosure is not limited thereto.

Additionally, the second processing unit 123 of the projection device 120 may further generate adjusted first calibration image information according to the calibrated projection corner coordinates, and send the adjusted first calibration image information to the image processing unit 124. Correspondingly, the image processing unit 124 may control the light modulation module 126, so that the light modulation module 126 converts the illumination beam into the image beam corresponding to the adjusted first calibration image based on the adjusted first calibration image information, and the projection lens 127 projects the image beam corresponding to the adjusted first calibration image.

The image beam may be projected by the projection lens 127 to form the adjusted first calibration image onto a projection surface (such as a screen and/or wall surface).

In FIG. 1, the mobile device 110 may be a portable electronic device with processing and communication capabilities, such as a smartphone, tablet computer, notebook computer, or wearable device with image capture and computing capabilities. It may embed or externally connect various sensing circuits and display circuits to provide a user operation interface and execute image analysis processing.

The camera unit 111 may be a digital camera circuit, which may be embedded inside the mobile device 110, or externally connected through wired/wireless manners. The camera unit 111 may include an image sensor (such as a CMOS sensor), a lens module, and related image processing circuits to capture images in the environment and convert into digital image data and/or image information.

The first storage unit 112 may include any type of fixed or removable storage device, such as Random Access Memory (RAM), Read-Only Memory (ROM), flash Memory, cache, Solid-state Drive (SSD), Hard Drive Disk (HDD), memory card, USB flash drive, or any combination thereof.

The first processing unit 113 may be a logic processor with data computing and control functions, such as a Central Processing Unit (CPU), a Digital Signal Processor (DSP), an Application Processor (AP), a System-on-Chip (SoC), or combinations thereof, for executing function modules such as image processing analysis and obstacle avoidance projection methods.

The first communication unit 114 may support wired or wireless data transmission methods to establish connection with the projection device 120 and transmit related information such as projection range coordinates. The data transmission methods may include at least one of the following communication protocols such as Wi-Fi (IEEE 802.11), Bluetooth, Near Field Communication (NFC), Zigbee, 4G mobile network (including 4G mobile network, 5G mobile network, or other mobile communication standards compliant with ITU recommendations), Universal Serial Bus (USB), Universal Asynchronous Receiver/Transmitter (UART), or Ethernet.

The display unit 115 may be various display devices, such as Liquid Crystal Display (LCD), Organic Light Emitting Diode (OLED) display modules, electronic paper modules, or other display devices with graphical user interface functions, for presenting reference images or application program operation screens. In some embodiments, the display unit 115 may be integrated with an input interface module, such as being integrated with a touch panel as a touch display module.

The projection device 120 may be a single integrated projection equipment, or a combination device including multiple modules, such as a laser projector, a Digital Light Processing (DLP) projector, an LCD projector, or a short-throw laser projection module. It may support fixed or portable installation and have keystone calibration and projection region adjustment functions.

The implementation of the second communication unit 121 of the projection device 120 may correspond to or be the same as the first communication unit 114 to achieve data or instruction transmission with the mobile device 110.

The second storage unit 122 of the projection device 120 has the same properties as the first storage unit 112, and may also contain at least one memory module among RAM, ROM, flash memory, SSD, and HDD.

The second processing unit 123 of the projection device 120 may be a main processor for controlling the operation of the projection device, and may also be at least one of SoC, FPGA, microcontroller (MCU), DSP, or embedded processor circuit.

The image processing unit 124 of the projection device 120 may be a processor specifically for processing image content, for processing calibrated image information, adjusting output screens, and controlling the light modulation module 126.

The illumination system 125 of the projection device 120 includes one or more light source modules, wavelength conversion devices, beam splitting and combining modules, collimating lenses, focus lenses and light homogenizing elements. The light source modules are, for example, laser light sources, LED light sources, or/and xenon lamps. The beam splitting and combining modules include, for example, at least one of or a combination of reflectors, beam splitters, and beam combiners. In one embodiment, the second processing unit 123 is coupled to the illumination system 125 and is adapted to control the illumination system 125.

The light modulation module 126 is, for example, a reflective light modulator such as a Liquid Crystal On Silicon panel (LCoS panel), a Digital Micro-mirror Device (DMD). In some embodiments, the light modulation device 2 may also be a transmissive light modulator such as a transparent liquid crystal panel, an electro-optical modulator, a magneto-optic modulator, an acousto-optic modulator (AOM). The disclosure does not limit the form and type of the light modulation module 126. Regarding the method by which the light modulation module 126 converts the illumination beam into the image beam, for the detailed steps and implementation methods, sufficient teaching, suggestions, and implementation instructions may be obtained from the ordinary knowledge in the technical field, so details will not be repeated here.

The projection lens 127 may be a fixed focus or zoom lens module for projecting the modulated image beam onto a predetermined projection surface. The projection lens 127 may also include a focusing mechanism, lens movement mechanism, or optical deformation compensation module. The projection lens 127 includes, for example, a combination of one or more optical lenses with refractive power, such as various combinations of non-planar lenses including biconcave lenses, biconvex lenses, concave-convex lenses, convex-concave lenses, plano-convex lenses, and plano-concave lenses. In one embodiment, the projection lens 127 may further include planar optical lenses to project the image beam from the light modulation module 126 to the projection target in a reflective manner. The disclosure does not limit the form and type of the projection lens light modulation module 126.

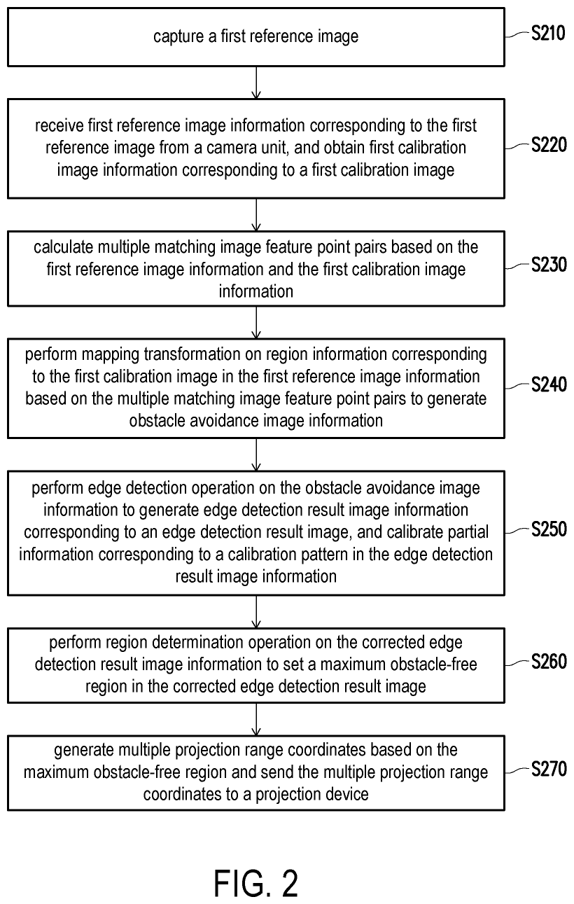

Please refer to FIG. 2, which is a flowchart of an obstacle avoidance projection method of the first embodiment of the disclosure. The method of this embodiment may be executed by the mobile device 110 in FIG. 1, and the details of each step in FIG. 2 are described below together with the components shown in FIG. 1.

In Step S210, the camera unit 111 captures a first reference image, in which the first reference image includes a first calibration image projected by the projection device 120 onto the projection surface according to first calibration image information, and the first calibration image includes a calibration pattern. To further explain, the first calibration image projected by the projection device 120 onto the projection surface according to the first calibration image information may be a first calibration image projected by the projection device 120 according to original first calibration image information, or an adjusted first calibration image projected by the projection device 120 onto the projection surface according to adjusted first calibration image information, in which when the second processing unit 123 of the projection device 120 does not execute image keystone calibration based on device posture information of the projection device 120, the projection device 120 projects the first calibration image according to the original first calibration image information.

FIG. 3A is a schematic diagram of a first calibration image of the first embodiment of the disclosure. FIG. 3B is a schematic diagram of a mobile device preview screen of the first embodiment of the disclosure.

After receiving an obstacle avoidance function activation instruction from the mobile device 110, the projection device 120 projects the first calibration image 310 onto the corresponding projection surface. Referring to FIG. 3A, the first calibration image 310 includes a calibration pattern 311.

Please refer to FIG. 1, FIG. 3A, and FIG. 3B together. After the obstacle avoidance function in the operation interface of the application program 112a of the mobile device 110 is activated, the first processing unit 112 correspondingly activates the image capture function of the camera unit 111, and the display unit 115 displays a preview screen as shown in FIG. 3B in an operation interface 320 of the application program 112a. Thereafter, the user of the mobile device 110 may operate the camera unit 111 to capture the first calibration image 310 projected onto the projection surface, and the image captured by the camera unit 111 may be presented by the display unit 115 in the operation interface 320 of the application program 112a for the user to confirm successful capture.

In the scenario in FIG. 3B, the image obtained by the camera unit 111 through image capture may be understood as the first reference image 330. As may be seen from FIG. 3B, an obstacle 340 is within the projection range corresponding to the first calibration image 310 projected on the projection surface by the projection device 120. In the disclosure, an obstacle being in the projection range is defined as the projection image being at least partially projected onto the obstacle. In other words, if the projection device 120 projects other images onto the projection surface in the current manner, the quality of the projection image is affected by the obstacle 340.

In the scenarios in FIG. 3A and FIG. 3B, although the calibration pattern 311 in the first calibration image 310 is illustrated in a form similar to a Quick Response (QR) code, it is merely used for example and is not intended to limit possible implementations of the disclosure. In other embodiments, designers may set the required calibration pattern according to needs. Furthermore, in the scenarios in FIG. 3A and FIG. 3B, the calibration pattern 311 is located at the center of the first calibration image 310. The calibration pattern 311 may also be located at other positions in the first calibration image 310, for example, at the edge or corner of the first calibration image 310. The user has to ensure that the first reference image 330 includes the complete first calibration image 310.

Referring to FIG. 2 again, after capturing the first reference image 310, in Step S220, the first processing unit 113 receives first reference image information corresponding to the first reference image 330 from the camera unit 111, and obtains first calibration image information corresponding to the first calibration image 310.

In some embodiments, the first calibration image information may be pre-downloaded through the Internet at an address designated by the application program 112a and stored in the first storage unit 112. In other embodiments, the first calibration image information may also be transmitted from the projection device 120 to the mobile device 110 when the mobile device 110 establishes a connection with the projection device 120 to be stored in the first storage unit 112, thereby ensuring that the first calibration image information stored by the mobile device 110 and the projection device 120 has the same content.

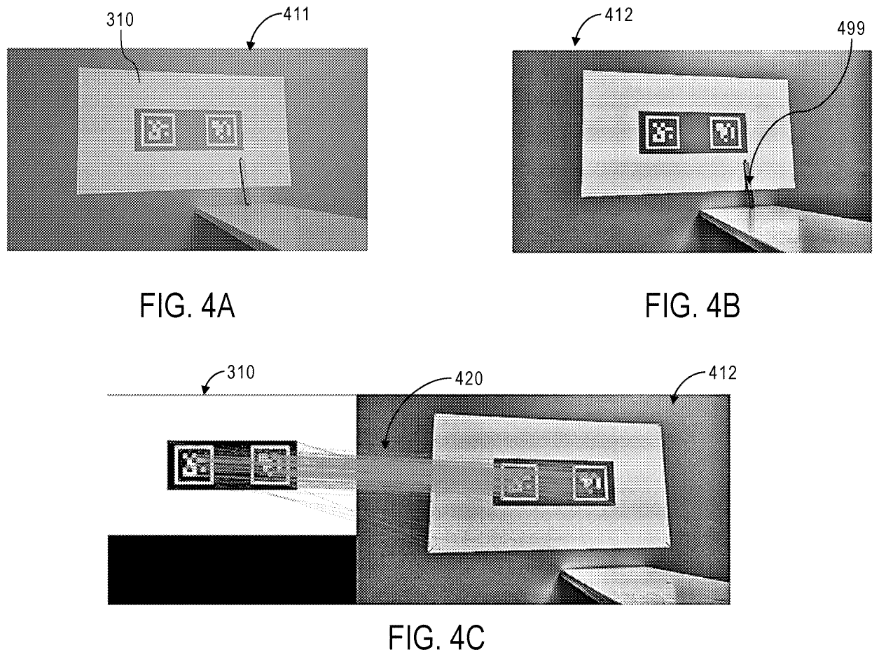

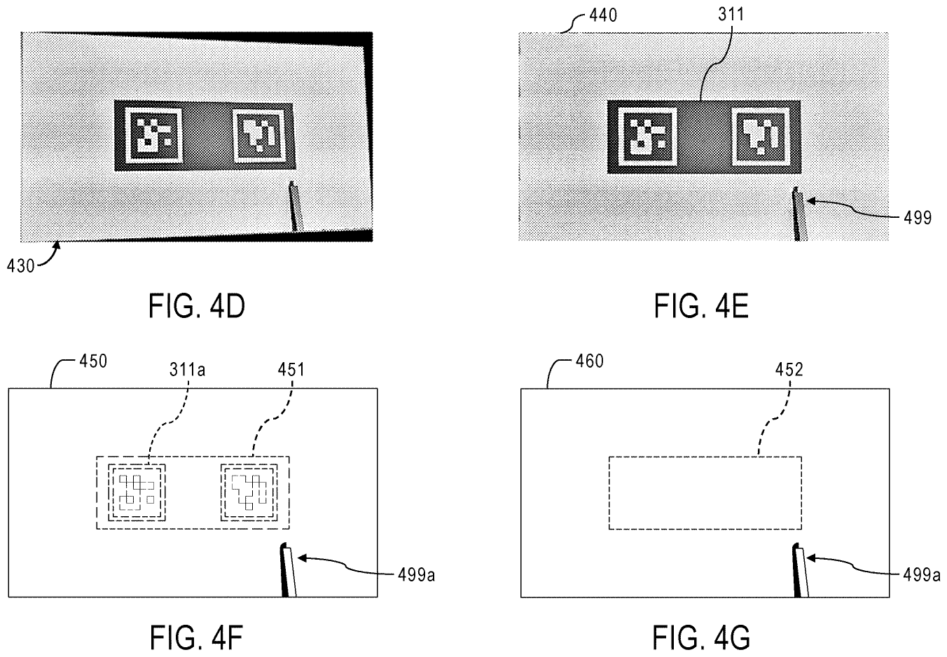

The following will be further explained together with the experimental images in FIG. 4A to FIG. 4G. FIG. 4A is an original first reference image captured by the camera unit of the mobile device in the first embodiment of the disclosure; FIG. 4B is the first reference image after preprocessing by the first processing unit in the first embodiment of the disclosure; FIG. 4C is a schematic diagram of matching between the first calibration image and the first reference image for image feature matching in the first embodiment of the disclosure; FIG. 4D is an image region corresponding to the first calibration image in the first reference image after mapping transformation in the first embodiment of the disclosure; FIG. 4E is an obstacle avoidance image generated by applying another mapping transformation to the image region in FIG. 4D; FIG. 4F is an edge detection result image generated after performing edge detection operation on the obstacle avoidance image in FIG. 4E; FIG. 4G is an edge detection result image after applying region masking of the first embodiment of the disclosure.

Referring to FIG. 4A and FIG. 4B. In the present embodiment, the first processing unit 113 may, for example, preprocess an original first reference image 411 to generate a first reference image 412 after preprocessing. More specifically, after the camera unit 111 captures the first reference image 411 in response to the obstacle avoidance function option being activated from a user, the first processing unit 113 may first perform one or more preprocessing operations on the original first reference image information generated by the camera unit 111 to facilitate subsequent analysis/computation. In different embodiments, the one or more preprocessing operations include, for example, at least one of the following: converting original image information to grayscale information, enhancing contrast by Contrast Limited Adaptive Histogram Equalization (CLAHE), or other image processing methods, but the disclosure is not limited thereto.

As may be seen from FIG. 4A and FIG. 4B, the current projection range of the projection device 120 includes a portion of an obstacle 499.

Referring to FIG. 2, in Step S230, the first processing unit 113 calculates multiple matching image feature point pairs based on the first reference image information and the first calibration image information.

Referring to FIG. 4C, in the embodiment, the left side shows the first calibration image 310, and the right side shows the first reference image 412 (after preprocessing). Each connecting line 420 between the two images connects an image feature point of the first calibration image 310 and an image feature point of the first reference image 412 at both ends respectively. Here, the matching image feature points in the first calibration image 310 and the first reference image 412 are referred to as a matching image feature point pair.

In some embodiments, the first processing unit 113 may further perform filtering operations on the matching image feature point pairs in the first calibration image 310 and the first reference image 412. The filtering operations are performed to filter the matching image feature point pairs in the first calibration image 310 and the first reference image 412, so as to retain matching image feature point pairs with good matching characteristics.

In some embodiments, the first processing unit 113 further determines whether the number of the matching image feature point pairs is greater than a preset threshold number. If yes, then the first processing unit 113 may proceed with subsequent operations of the projection obstacle avoidance method; if no, then the first processing unit 113 may control the display unit 115 to display corresponding error messages or warning messages, and/or return to Step S210 to recapture the first reference image.

Referring to FIG. 1 and FIG. 2 again, after calculating the multiple matching feature image feature point pairs in Step S230, in Step S240, the first processing unit 113 performs a mapping transformation on region information corresponding to the first calibration image 310 from the first reference image information based on the multiple matching image feature point pairs to generate obstacle avoidance image information.

In some embodiments, the first processing unit 113 may generate the obstacle avoidance image information based on a perspective transformation method. Specifically, in this embodiment, the first processing unit 113 first generates a first transformation matrix for mapping from the coordinate system of the first calibration image to the coordinate system of the first reference image based on the multiple matching image feature point pairs, and performs inverse matrix operations on the first transformation matrix to generate a second transformation matrix.

Next, the first processing unit 113 may use the first transformation matrix to map the first calibration image information into the first reference image information to determine the region information corresponding to the first calibration image 310 in the first reference image information.

In an embodiment of the disclosure, the region information of a certain image region may, for example, describe relevant information of spatial geometric attributes and image content features of a specific region in the image, including but not limited to geometric information and content information.

The geometric information of an image region may refer to the spatial distribution information of this image region in the image coordinate system, for example, the boundary coordinates of the region (such as upper-left and lower-right corner positions), center point position, length and width dimensions, area size, or its shape type (such as rectangle, polygon, or irregular block). In addition, the information may also include the position of the region relative to the overall image (such as located at the image center or corners) and relative positional relationship thereof with other regions.

In addition, the content information of an image region may refer to the image features possessed by pixels in this image region, for example, pixel brightness values, grayscale values, color distribution (such as RGB average values or standard deviation), texture features (such as edge density, pattern repeatability), or whether the region contains predetermined target patterns (such as specific marks or structural patterns). Such information may be calculated and captured by image processing algorithms, serving as the basis for subsequent recognition, calibration, or control operations.

Referring to FIG. 4D together with FIG. 4E, the region information corresponding to the first calibration image 310 in the first reference image information may, for example, correspond to the image region 430 extracted from the first reference image in FIG. 4D. That is, the region information corresponding to the first calibration image 310 may, for example, include geometric information and content information related to the image region 430, but the disclosure is not limited thereto.

Next, the first processing unit 113 may use the second transformation matrix to map the region information to obstacle avoidance image information.

The obstacle avoidance image information may, for example, correspond to the obstacle avoidance image 440 in FIG. 4E. That is, the obstacle avoidance image information may, for example, include geometric information and content information related to the obstacle avoidance image 440, but the disclosure is not limited thereto.

Referring to FIG. 1 and FIG. 2, after generating the obstacle avoidance image information in Step S240, in Step S250, the first processing unit 113 performs edge detection operation on the obstacle avoidance image information to generate edge detection result image information corresponding to an edge detection result image, and calibrates partial information corresponding to the calibration pattern 311 in the edge detection result image information.

In the embodiment of the disclosure, the edge detection result image information refers to the image information generated after performing edge detection processing (such as Sobel, Canny, or Laplacian algorithms) on the original obstacle avoidance image information. The image information includes but is not limited to edge pixel position information and/or edge intensity information, where the edge pixel position information is configured to describe the spatial coordinates of pixels determined as edges in the image. In addition, the edge intensity information refers to the gradient amplitude of edge pixels in the image, reflecting the clarity or contrast intensity of edges, which may serve as the basis for filtering weak edges or noise edges.

Referring to FIG. 4F, the edge detection result image information generated after the obstacle avoidance image information undergoes edge detection operation may, for example, correspond to an edge detection result image 450. As seen from FIG. 4F, the edge detection result image 450 further includes an obstacle edge 499a corresponding to the obstacle 499 in FIG. 4B to FIG. 4E. In other words, the edge detection result image information still contains edge information related to the obstacle 499.

Next, referring to FIG. 3A together, the first processing unit 113 may obtain geometric information of a first image region occupied by the calibration pattern 311 in the first calibration image 310.

Afterward, the first processing unit 113 performs region mask coverage on the edge detection result image information according to the geometric information of the first image region to exclude a pattern edge 311a corresponding to the calibration pattern 311 in the edge detection result image 450.

Referring to FIG. 4F and FIG. 4G, specifically, the first processing unit 113 first determines a mask region 451 in the edge detection result image 450 according to the geometric information of the first image region, and applies mask information to the mask region 451 of the edge detection result image 450. As shown in FIG. 4G, the edge pixels within the mask region 452 are covered (for example, setting pixel values to zero or marking as ignore regions), forming an edge detection result image 460 corresponding to the corrected edge detection result image information, thereby achieving the purpose of removing partial information corresponding to the calibration pattern 311 in the edge detection result image information. As can be seen from FIG. 4G, the corrected edge detection result image 460 no longer includes partial information (for example, edge information) corresponding to the calibration pattern 311.

By this mask processing, the edges corresponding to the calibration pattern 311 in the corrected edge detection result image 460 do not participate in subsequent analysis, thereby effectively excluding the influence caused by the calibration pattern 311 on subsequent operations. The corrected edge detection result image 460 merely contains the obstacle edge 499a related to the obstacle 499.

Referring to FIG. 2 again, in Step S260, the first processing unit 113 performs region determination operation on the corrected edge detection result image information to set a maximum obstacle-free region in the corrected edge detection result image 460. Specifically, Step S260 in FIG. 2 further includes Steps S511 to S520.

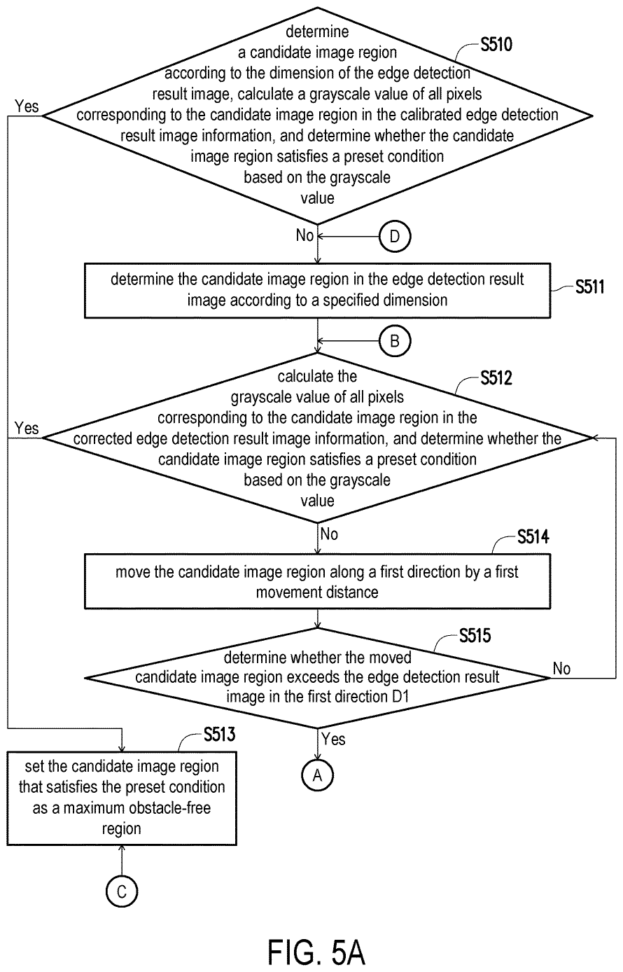

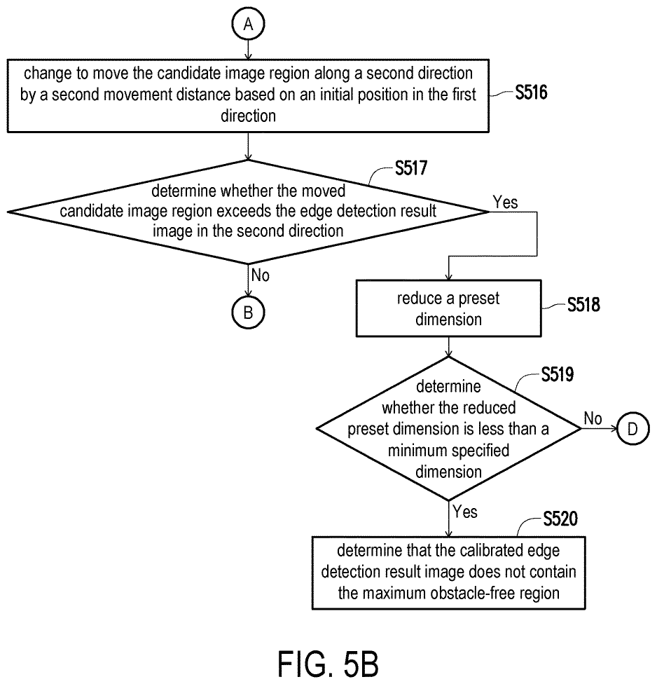

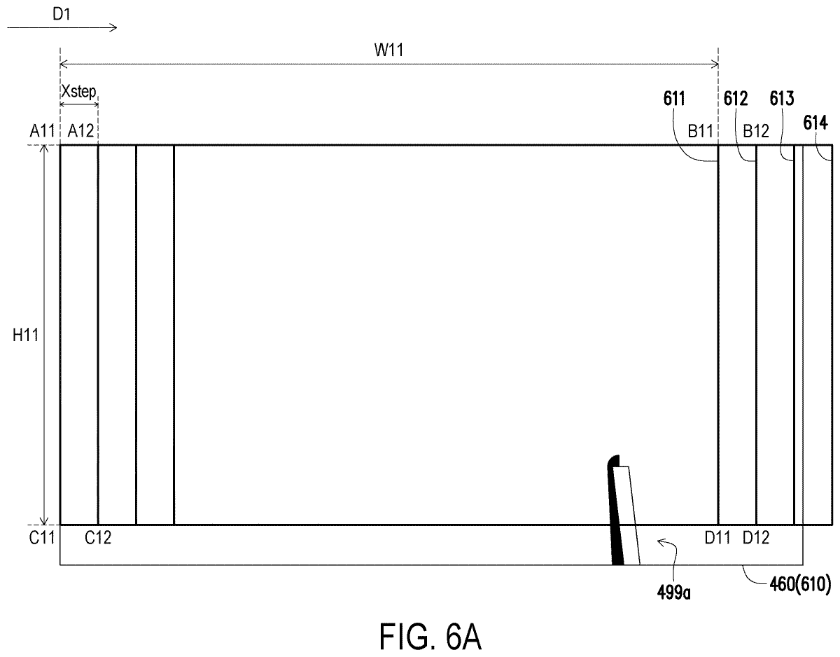

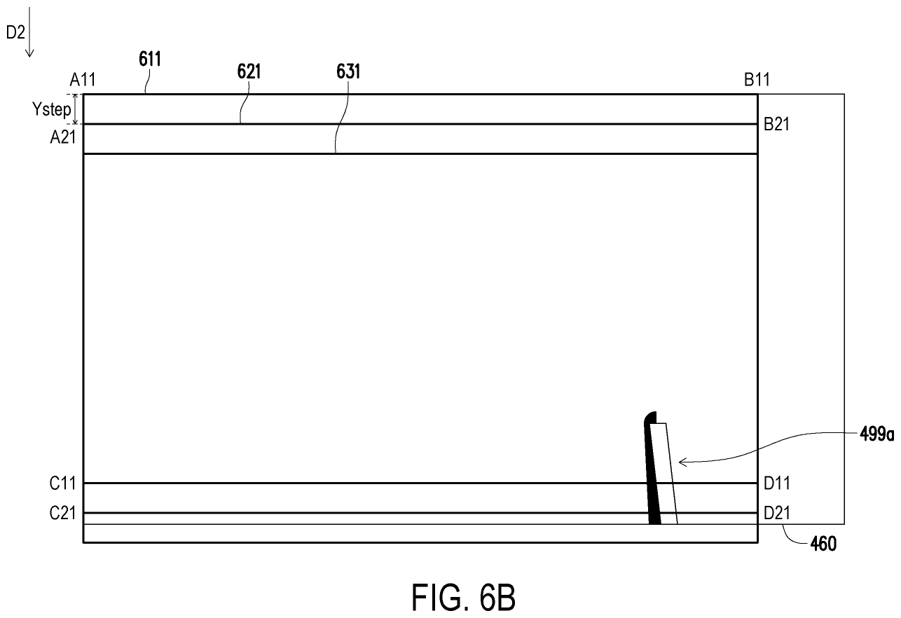

FIG. 5A and FIG. 5B are flowcharts of region determination operation performed on edge detection result image information in the first embodiment of the disclosure. To make the concepts in FIG. 5A and FIG. 5B easier to understand, FIG. 6A and FIG. 6B are additionally provided for illustration, where FIG. 6A and FIG. 6B are application schematic diagrams of the flowcharts of region determination operation in the first embodiment of the disclosure.

In some embodiments, in the initial stage of the step where the first processing unit 113 performs region determination operation on the corrected edge detection result image information to set a maximum obstacle-free region in the corrected edge detection result image 460, Step S510 is first performed, that is, the first processing unit 113 first determines a candidate image region 610 according to the dimension of the edge detection result image 460. The first processing unit 113 calculates a grayscale value of all pixels corresponding to the candidate image region 610 in the corrected edge detection result image information, and determines whether the candidate image region 610 satisfies a preset condition based on the grayscale value. If yes, then the first processing unit 113 may proceed to execute Step S513; if no, then the first processing unit 113 may proceed to execute Step S511. The candidate image region is determined according to the dimension of the edge detection result image, the grayscale value of all pixels in the candidate image region corresponding to the corrected edge detection result image information are calculated, and whether the candidate image region satisfies the preset condition is determined based on the grayscale value.

Referring to FIG. 5A, in Step S511, the first processing unit 113 determines a candidate image region 611 in the edge detection result image 460 according to a preset dimension.

In the scenario in FIG. 6A, the preset dimension has, for example, a width W11 and a height H11, and the ratio between the width W11 and the height H11 may conform to a preset aspect ratio, and the preset dimension is smaller than the dimension of the edge detection result image 460. Preferably, this preset aspect ratio is the same (for example, 16:9) as the current projection aspect ratio of the projection device 120, such as the same as the aspect ratio of the first calibration image 310. For clear definition, the width in the aspect ratio is defined as, for example, the length in the Y-axis direction in the edge detection result image 460, while the height is defined as the length in the X-axis direction in the edge detection result image 460.

In one embodiment, in the initial stage of the region determination operation, the first processing unit 113 first determines the candidate image region 611 corresponding to the preset dimension at an initial position in the edge detection result image 460.

In FIG. 6A, the initial position is, for example, at the upper left corner of the edge detection result image 460. The first processing unit 113 may, for example, determine a region having the width W11 and the height H11 in the edge detection result image 460, and then determine the candidate image region 611 by aligning the upper left corner of this region with the initial position, but the disclosure is not limited thereto. Specifically, the initial position in the edge detection result image 460 is, for example, the position of coordinate (x, y)=(0,0) in the edge detection result image 460, and according to the preset width W11 and the height H11, coordinates A11(0,0), B11(W11,0), C11(0,H11), D11(W11,H11) are determined as the four corner coordinates of the initial candidate image region 611, thereby defining the candidate image region 611.

In Step S512, the first processing unit 113 calculates the grayscale value of all pixels corresponding to the candidate image region 611 in the corrected edge detection result image information, and determines whether the candidate image region 611 satisfies a preset condition based on the grayscale value. If yes, then the first processing unit 113 may proceed to execute Step S513; if no, then the first processing unit 113 may proceed to execute Step S514.

The grayscale value is, for example, an average grayscale value or a sum of grayscale values of all pixels in the candidate image region 611.

In the embodiment where the considered grayscale value is a sum of grayscale values or an average grayscale value, the first processing unit 113 may, for example, first calculate integral image information of the edge detection result image information, and then determine the grayscale value of the candidate image region 611 accordingly. The calculation of the integral image information may be performed after generating the corrected edge detection result image information and before starting the region determination operation.

According to the integral image information, the first processing unit 113 may calculate the sum of grayscale values of the candidate image region 611 based on the integral image information and the four corner coordinates A11(0,0), B11(W11,0), C11(0,H11), D11(W11,H11) of the candidate image region 611. Specifically, the integral image information contains integral values of any coordinate in the edge detection result image information, and the sum of grayscale values of the candidate image region 611 may be calculated using the formula “coordinate D integral value-coordinate B integral value coordinate C integral value +coordinate A integral value” to calculate the sum of grayscale values of the candidate image region 611. The average grayscale value may be obtained by dividing the sum of grayscale values by the total number of pixels within the candidate image region 611.

After determining the grayscale value corresponding to the candidate image region 611, the first processing unit 113 may determine whether the grayscale value is equal to a possible maximum value. If yes, then the first processing unit 113 may determine that the candidate image region 611 satisfies the preset condition; if no, then the first processing unit 113 may determine that the candidate image region 611 does not satisfy the preset condition.

The possible maximum value is, for example, the grayscale value correspondingly presented when the considered candidate image region is a full background color image region.

For example, assuming the considered background color is white (corresponding to grayscale value 255), and the considered grayscale value is the sum of grayscale values, when the considered candidate image region is a full background color image region, the corresponding possible maximum value is, for example, “255*total number of pixels within the candidate image region”.

For another example, assuming the considered background color is white, and the considered grayscale value is the average grayscale value, when the considered candidate image region is a full background color image region, the corresponding possible maximum value is 255.

Furthermore, when the first processing unit 113 determines that the grayscale value corresponding to a certain candidate image region is equal to the possible maximum value, this represents that the candidate image region information (for example, content information and/or geometric information) corresponding to this candidate image region does not include any obstacle edge 499a. In other words, if the projection device 120 uses the range of this candidate image region as the subsequent projection range, it may avoid this projection range covering the obstacle 499.

On the other hand, as shown in the candidate image region 611 in FIG. 6A, when the first processing unit 113 determines that the grayscale value corresponding to a certain candidate image region is not equal to the possible maximum value, for example, less than the possible maximum value, this represents that the candidate image region information corresponding to this candidate image region includes at least a portion of the obstacle edge 499a. In other words, if the projection device 120 uses the range of this candidate image region 611 as the subsequent projection range, this projection range still covers the obstacle 499.

In another embodiment, since there may be a certain degree of imperfections (for example, stains, dents, shadows, and/or not being completely white) on the projection surface, even if the candidate projection region does not actually contain the obstacle edge 499a, it may still not be a full background color image region. Considering this situation, the setting of the preset condition may include a tolerance range.

For example, after determining the grayscale value corresponding to the considered candidate image region, the first processing unit 113 may determine whether the grayscale value is greater than a preset threshold. If yes, then the first processing unit 113 may determine that the candidate image region satisfies the preset condition; if no, then the first processing unit 113 may determine that the candidate image region does not satisfy the preset condition.

For example, assuming the considered background color is white, and the considered grayscale value is the sum of grayscale values, the preset threshold may be set as “(255−error value)*number of pixels within the candidate image region”, where the error value may be set to a corresponding value (for example, 2) according to the degree of imperfection/error that the designer can tolerate.

For another example, assuming the considered background color is white, and the considered grayscale value is the average grayscale value, then the preset threshold may be set as “(255−error value)”, but the disclosure is not limited thereto.

In the scenario in FIG. 6A, since the candidate image region information (for example, content information and/or geometric information) corresponding to the candidate image region 611 includes a portion of the obstacle edge 499a, in Step S512, it is determined that the candidate image region 611 does not satisfy the preset condition, and Step S514 is subsequently executed to move the candidate image region along a first direction D1 by a first movement distance Xstep.

In the scenario in FIG. 6A, the first processing unit 113 may move the candidate image region 611 along the first direction D1 by the first movement distance Xstep, where the first movement distance Xstep may be set to any value according to the requirements from the designer, for example, the first movement distance may be a preset number of pixels (for example, 20 pixels). The four corner coordinates of the candidate image region 612 after the candidate image region 611 is moved along the first direction D1 by the first movement

### Distance Xstep Are A12(xstep,0), B12(xstep+w11,0), C12(xstep, H11), D12(xstep+w11,h11).

In Step S515, the first processing unit 113 determines whether the moved candidate image region exceeds the edge detection result image 460 in the first direction D1. If yes, then the first processing unit 113 subsequently executes Step S516; if no, then the first processing unit 113 executes Step S512.

In the scenario in FIG. 6A, the candidate image region 612 after the candidate image region 611 is moved in the first direction D1 does not exceed the edge detection result image 460 in the first direction D1, and Step S512 is correspondingly executed. Specifically, it is determined whether the candidate image region 612 exceeds the edge detection result image 460 in the first direction D1 by whether the X-coordinate of the corner point B (Xstep+W11, 0) of the candidate image region 612 is greater than the width of the edge detection result image 460.

In other words, the first processing unit 113 performs the same calculation and determination for the candidate image region 612 according to the same method for calculating the grayscale value and determining whether the preset condition is satisfied regarding the candidate image region 611.

As may be seen from FIG. 6A, since the candidate image region 612 still includes a portion of the obstacle edge 499a, the first processing unit 113 may, for example, determine in Step S512 that the candidate image region 612 does not satisfy the preset condition, and subsequently execute Step S514 to move the candidate image region along the first direction D1 by the first movement distance Xstep to move to a next candidate image region 613 in the first direction D1.

In other words, in Steps S512 to S515, when the candidate image region is determined not to satisfy the preset condition, the unsatisfied candidate image region is changed to the next candidate image region. The unsatisfied candidate image region is moved along the first direction D1 to the next candidate image region, until a candidate image region exceeds the edge detection result image in the first direction D1, thereby sequentially determining whether the candidate image region at each position in the first direction D1 satisfies the preset condition. In this embodiment, the boundary of the candidate image region 611, the candidate image region 612, and the boundary of the candidate image region 613 are different in the first direction D1.

In the scenario in FIG. 6A, the candidate image regions 611 to 613 all still contain the obstacle edge 499a, and the candidate image region 614 exceeds the edge detection result image in the first direction D1, so the operation proceeds to Step S516.

Please refer to FIG. 6B, which is a schematic diagram continuing from FIG. 6A illustrating the region determination operation along a second direction D2.

In Step S516, the first processing unit 113 instead to move the candidate image region along the second direction D2 by a second movement distance Ystep based on the initial position in the first direction D1.

In the scenario in FIG. 6B, when the first processing unit 113 executes Step S516, the candidate image region 611 corresponding to the initial position in the first direction D1 is moved along the second direction D2 by the second movement distance Ystep to form a candidate image region 621. In other words, the four corner coordinates of the candidate image region 621 after the candidate image region 611 is moved along the second direction D2 by the second movement distance Ystep are A21(0, Ystep), B21(W11, Ystep), C21(0,H11+Ystep), and D21(W11, H11+Ystep).

The second movement distance Ystep may be set to any value by the designer according to requirements, where the second movement distance may be different from or the same as the first movement distance, and the second movement distance is, for example, a preset pixel number (for example, 15 pixels).

Next, in Step S517, the first processing unit 113 determines whether the moved candidate image region 611 exceeds the edge detection result image 460 in the second direction D2. If yes, then the first processing unit 113 proceeds to execute Step S518; if no, then the first processing unit 113 returns to execute Step S512.

In the scenario in FIG. 6B, the candidate image region 611 after being moved in Step S516 becomes the candidate image region 621, and the first processing unit 113 may proceed to execute Step S512 after determining that the candidate image region 621 does not exceed the edge detection result image 460 in the second direction D2. Specifically, it is determined whether the candidate image region 621 exceeds the edge detection result image 460 in the second direction D2 by whether the Y coordinate of the corner point C(0,H11+Ystep) of the candidate image region 621 is greater than the height of the edge detection result image 460.

In other words, when the candidate image region is moved from the initial position in the first direction D1 along the second direction D2 and does not exceed the edge detection result image 460, the operation proceeds to the process of Steps S512 to 515 again, sequentially moving the candidate image region along the first direction D1 and determining whether each candidate image region in the first direction D1 meets the preset condition, until the candidate image region exceeds the edge detection result image 460 in the first direction D1, then Steps S516 to S517 are executed again.

Furthermore, in Step S517, when the candidate image region moved along the second direction D2 exceeds the edge detection result image 460, then the first processing unit 113 proceeds to Step S518.

In the scenario in FIG. 6B, when the process executes to the candidate image region 621 at the initial position in the first direction D1 being moved along the second direction D2 by the second movement distance Ystep to form the candidate image region 631, and the candidate image region 631 exceeds the edge detection result image 460 in the second direction D2, the operation proceeds to Step S518. In this embodiment, the boundary of the candidate image region 611, the candidate image region 621, and the boundary of the candidate image region 631 are different in the second direction D2.

In Step S518, the first processing unit 113 reduces the preset dimension, and then, in Step S519, the first processing unit 113 determines whether the reduced preset dimension is less than a minimum specified dimension.

In one embodiment, the first processing unit 113 reduces the width W11 and the height H11 according to a specific ratio to determine the reduced preset dimension. For example, the first processing unit 113 multiplies the height H11 by a fixed reduction ratio as the new height, then multiplies the new height by the preset aspect ratio to obtain the new width. Thereby, the reduced specified dimension may still have the preset aspect ratio.

The minimum specified dimension corresponds to the minimum allowable projection range. If the reduced preset dimension is less than the minimum preset dimension, it means that the projection device 120 cannot avoid the obstacle 499 while providing a sufficiently large projection range. Therefore, the first processing unit 113 proceeds to Step S520, determining that the corrected edge detection result image 460 does not contain the maximum obstacle-free region.

If the corrected edge detection result image 460 is determined not to contain the maximum obstacle-free region, the first processing unit 113 ends the projection obstacle avoidance function. In addition, the first processing unit 113 may also control the display unit 115 to display an obstacle avoidance failure notification prompt, or transmit obstacle avoidance failure notification image information to the projection device 120 to be projected by the projection device 120, thereby notifying the user that the projection obstacle avoidance function execution has failed.

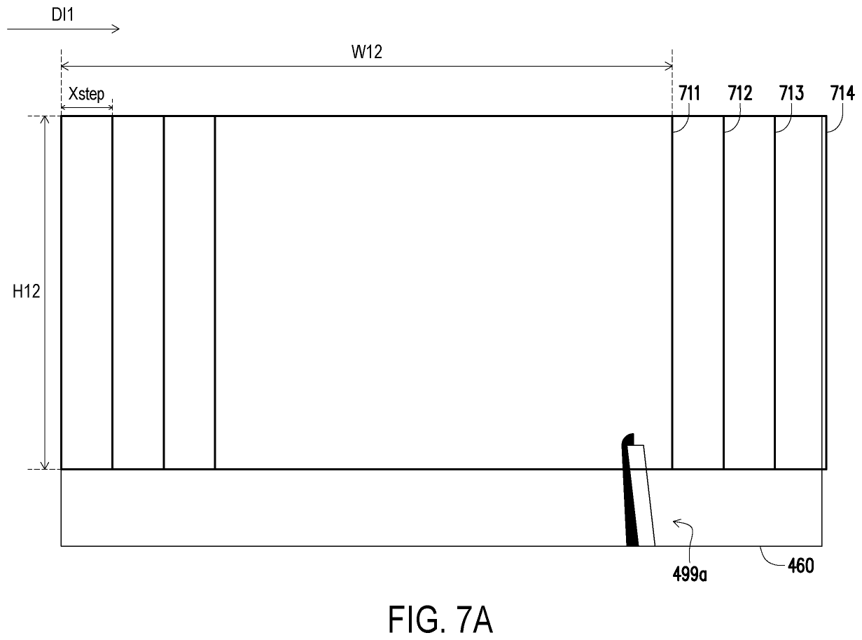

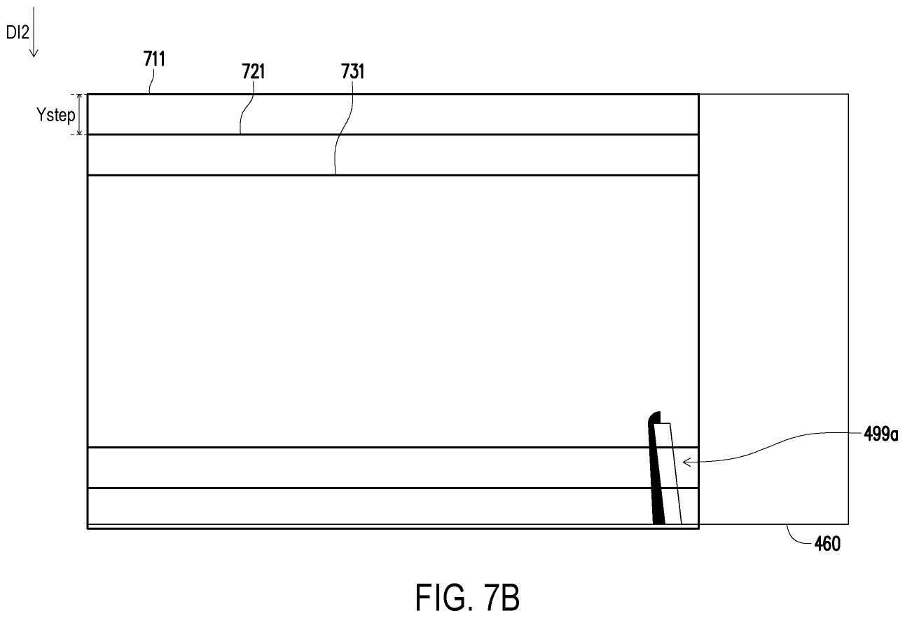

On the other hand, if the reduced preset dimension is not less than the minimum preset dimension, the first processing unit 113 returns to execute Steps S511 to S517 to attempt again to find a projection range that may avoid the obstacle 499 according to the reduced preset dimension. In other words, the projection device 120 still has the opportunity to provide a sufficiently large projection range while avoiding the obstacle 499. The following will be further explained together with FIG. 7A to FIG. 7B.

Please refer to FIG. 7A and FIG. 7B, which are schematic diagrams showing the region determination operation according to the reduced preset dimension. The reduced preset dimension is a preset dimension having a width W12 and a height H12.

Specifically, in the scenario in FIG. 7A to FIG. 7B, the first processing unit 113 sequentially obtains candidate image regions 711 to 714 spaced by the first movement distance Xstep according to Steps S511 to 515, and sequentially calculates the grayscale values of the candidate image regions 711 to 713 and determines whether the grayscale values meet the preset condition; when the moved candidate image region 714 exceeds the corrected edge detection result image 460 in the first direction D1, the operation proceeds to Steps S516 to S517, and it is changed to moving the candidate image region along the second direction D2 by the second movement distance Ystep based on the initial position candidate image region 711 in the first direction D1 to obtain candidate image region 721, and Steps S511 to 515 are executed; when the candidate image region 731 after being moved by the second movement distance Ystep along the second direction D2 exceeds the corrected edge detection result image 460 in the second direction D2, the operation proceeds to Step S518 again to reduce the preset dimension.

In the embodiment of the disclosure, the flow in FIG. 5A and FIG. 5B is recursively executed according to the foregoing Steps S511 to 520, until the first processing unit 113 determines in Step S512 that the currently considered candidate image region satisfies the preset condition, or determines in Step S521 that the reduced preset dimension is smaller than the preset dimension, but the disclosure is not limited thereto.

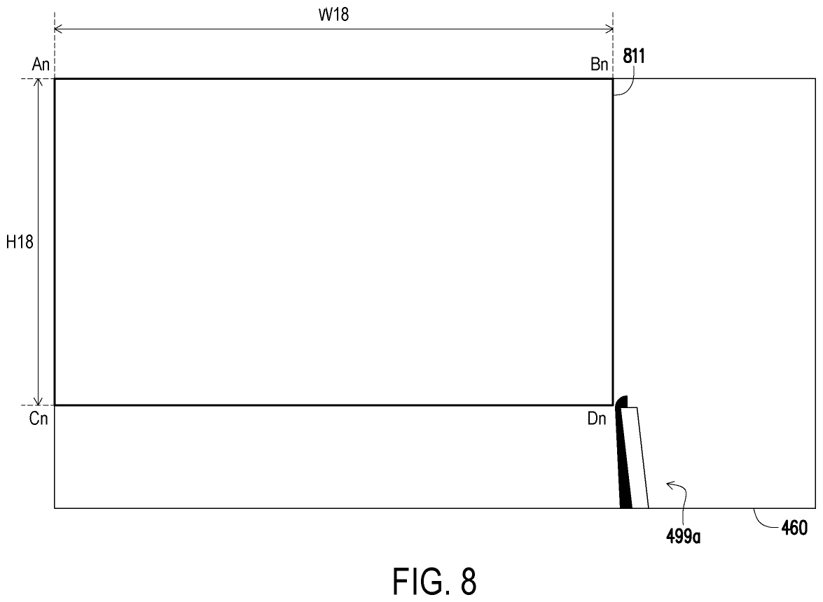

Please refer to FIG. 8, which is a schematic diagram showing the determination of the maximum obstacle-free region according to an embodiment of the disclosure.

In FIG. 8, it is assumed that the currently considered preset dimension has a width W18 and a height H18, and the first processing unit 113 determines a candidate image region 811 accordingly.

As may be seen from FIG. 8, the candidate image region (such as content information and/or geometric information) corresponding to the candidate image region 811 does not include any obstacle edge 499a. In this case, the first processing unit 113 determines that candidate image region 811 satisfies the preset condition according to the grayscale value corresponding to the candidate image region 811, and proceeds to execute Step S513.

Accordingly, in Step S513, the first processing unit 113 may set the candidate image region 811 that satisfies the preset condition as the maximum obstacle-free region. In other words, if the projection device 120 uses the projection surface range corresponding to candidate image region 811 as the subsequent projection range, it may avoid the projected image covering the obstacle 499.

Referring to FIG. 2, after setting the maximum obstacle-free region according to Step S260, in Step S270, the first processing unit 113 generates multiple projection range coordinates based on the maximum obstacle-free region (for example, the candidate image region 811), and sends the multiple projection range coordinates to the projection device 120.

The maximum obstacle-free region is a region defined by multiple corner coordinates in the edge detection result image 460. Specifically, for example, the four corner coordinates of the candidate image region 811 are An(0, 0), Bn(W18, 0), Cn(0, H18), Dn(W18, H18).

In one embodiment, the first processing unit 113 may obtain multiple calibrated projection corner coordinates (for example, the projection corner coordinates obtained by the projection device 120 after keystone calibration) used when the projection device 120 projects the first calibration image 310. Afterward, the first processing unit 113 may perform mapping transformation based on the multiple corner coordinates and the multiple calibrated projection corner coordinates to generate the multiple projection range coordinates.

Correspondingly, after the projection device 120 receives the multiple projection range coordinates from the mobile device 110, the projection device 120 may adjust the projection range accordingly, so that the adjusted projection range corresponds to the maximum obstacle-free region (for example, the candidate image region 811).

In one embodiment, after the first processing unit 113 generates the multiple projection range coordinates in Step S270, the first processing unit 113 may first control the display unit 115 to display the first reference image 412, and then mark the image region corresponding to the maximum obstacle-free region (for example, the candidate image region 811) on the first reference image 412 according to the multiple projection range coordinates. Afterward, the first processing unit 113 may further control the display unit 115 to display a calibration confirmation button for user confirmation.

After the user agrees to the maximum obstacle-free region by, for example, activating the calibration confirmation button, the first processing unit 113 may send the multiple projection range coordinates to the projection device 120.

In another embodiment, after the projection device 120 receives the multiple projection range coordinates, it may also project an adjustment preview projection image accordingly, and present the expected projection range (for example, marking the expected projection range in the projection image with corresponding peripheral frame lines) in the adjustment preview projection image according to the multiple projection range coordinates. Also, afterward, the first processing unit 113 may further control the display unit 115 to display a calibration confirmation button for user confirmation.

After the user agrees to the maximum obstacle-free region by, for example, activating the calibration confirmation button, the projection device 120 may substantially adjust the projection range to the expected projection range.

In some embodiments, some of the operations performed by the mobile device 110 above (for example, Step S220 to Step S270) may be executed by a remote server connected to the mobile device 110. In one embodiment, when the remote server executes Step S270, after determining the multiple projection range coordinates, it may send the multiple projection range coordinates to the projection device through the mobile device 110, but the disclosure is not limited thereto.

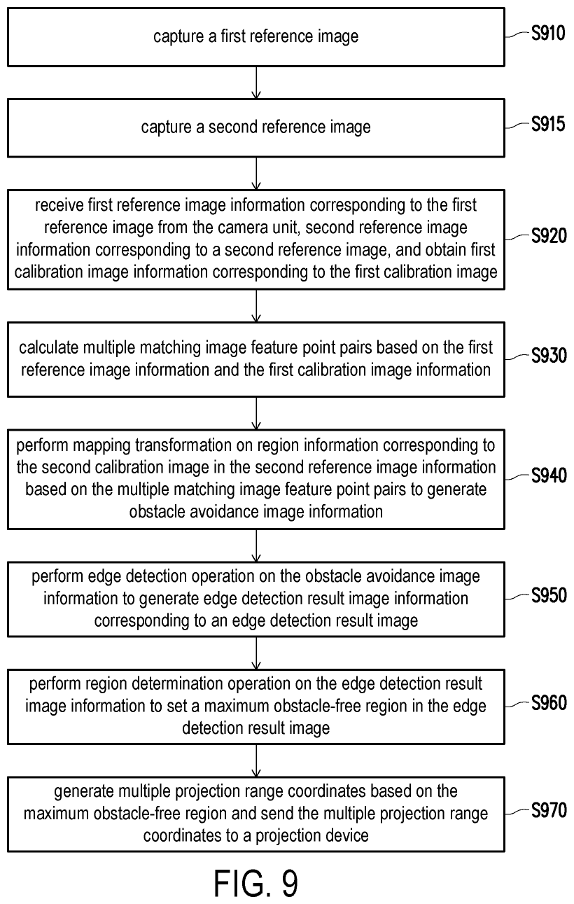

Please refer to FIG. 9, which is a flowchart of the obstacle avoidance projection method in a second embodiment of the disclosure. The obstacle avoidance projection method of Second embodiment includes Steps S910 to S970, and may be executed by the projection system 100 in First embodiment as shown in FIG. 1. The steps of Second embodiment will be described below with reference to the projection system 100 shown in FIG. 1.

In Step S910, the camera unit 111 captures a first reference image, in which the first reference image includes a first calibration image projected by the projection device 120 onto a projection surface according to first calibration image information, and the first calibration image includes a calibration pattern.

In the present embodiment, for the details of Step S910, reference may be made to the related description of Step S210 of First embodiment shown in FIG. 2, so details will not be repeated here.

In Step S915, the camera unit 111 captures a second reference image, in which the second reference image includes a second calibration image 350 projected by the projection device 120 onto the projection surface, and the second calibration image 350 is, for example, a background color image. Specifically, the background color image is a monochrome image, for example, an all-white image.

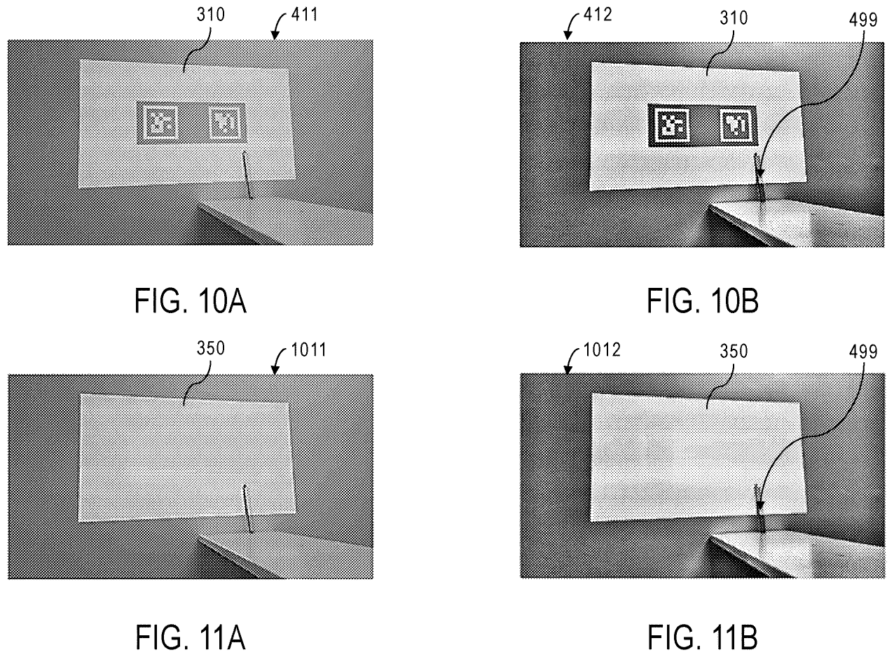

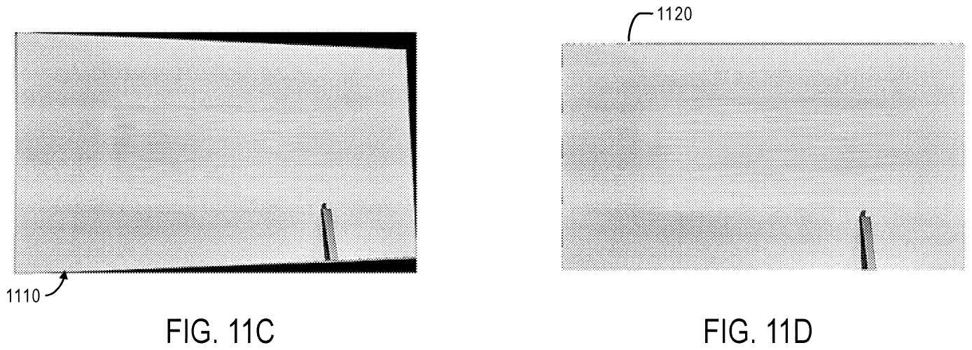

The following will be further explained with experimental images according to the second embodiment of the disclosure as shown in FIG. 10A to FIG. 11B. FIG. 10A is an original first reference image captured by the camera unit of the mobile device; FIG. 10B is a preprocessed first reference image; FIG. 11A is an original second reference image captured by the camera unit of the mobile device; FIG. 11B is a preprocessed second reference image.

Referring to FIG. 10A, the original first reference image 411 is, for example, an original image obtained by the camera unit 111 capturing the first calibration image 310 projected onto the projection surface in response to the obstacle avoidance function option being activated from a user.

Additionally, referring to FIG. 11A, an original second reference image 1011 is, for example, an original image obtained by the camera unit 111 capturing the second calibration image 350 projected onto the projection surface in response to the obstacle avoidance function option being activated from a user. Preferably, the user should operate the camera unit 111 to capture the second calibration image 350 projected onto the projection surface based on the same settings/position as when capturing the first calibration image 310, thereby capturing the second reference image 1011 and generating second reference image information.

In Step S920, the first processing unit 113 receives first reference image information corresponding to the first reference image 412 from the camera unit 111, second reference image information corresponding to a second reference image 1012, and obtains first calibration image information corresponding to the first calibration image.

Referring to FIG. 10B, in some embodiments, the first processing unit 113 preprocesses the original first reference image information to generate first reference image information corresponding to the preprocessed first reference image 412. Furthermore, referring to FIG. 11B, the first processing unit 113 may also perform the same preprocessing on the second reference image information as performed on the first reference image information to generate second reference image information corresponding to the preprocessed second reference image 1012.

For the specific content and acquisition method of the first calibration image 310 and related first calibration image information of this embodiment, reference may be made to the description of the first embodiment, so details will not be repeated here.

In Step S930, the first processing unit 113 calculates a plurality of matching image feature point pairs based on the first reference image information and the first calibration image information. For the detailed means of Step S930, reference may be made to all related descriptions of Step S230 of the first embodiment, so details will not be repeated here.

In Step S940, the first processing unit 113 performs mapping transformation on region information corresponding to the second calibration image 350 in the second reference image information based on the plurality of matching image feature point pairs to generate obstacle avoidance image information.

Specifically, in Step S940, the first processing unit 113 first generates a first transformation matrix for mapping from the coordinate system of the first calibration image to the coordinate system of the first reference image based on the plurality of matching image feature point pairs, and performs inverse matrix operation on the first transformation matrix to generate a second transformation matrix. In this embodiment, the detailed means and principles for generating the first transformation matrix and the second transformation matrix in Step S940 are the same as the detailed means and principles for generating the first transformation matrix and the second transformation matrix in Step S240 of the first embodiment, so details will not be repeated here.

Next, the first processing unit 113 uses the first transformation matrix to map the first calibration image information to the second reference image information to determine region information corresponding to the second calibration image 350 in the second reference image information.

The following will be further explained together with experimental images according to the second embodiment of the disclosure in FIG. 11C to FIG. 11D. FIG. 11C is an image region corresponding to the first calibration image in the second reference image after mapping transformation in Second embodiment of the disclosure; FIG. 11D is the obstacle avoidance image generated by applying another mapping transformation to the image region in FIG. 11C.

Please refer to FIG. 11B and FIG. 11C, the region information corresponding to the second calibration image 350 in the second reference image information may, for example, correspond to an image region 1110 contained in the second reference image 1012. That is, the region information corresponding to the second calibration image 350 in the second reference image 1012 may, for example, include geometric information and content information related to the image region 1110.

Next, the first processing unit 113 uses the second transformation matrix to map the region information to obstacle avoidance image information.

In this embodiment, the first reference image 412 and the second reference image 1012 are captured by the mobile device 110 at the same setting/position. Therefore, based on the first transformation matrix and the second transformation matrix generated from the match image features between the first reference image 412 and the first calibration image 310, the same perspective transformation effect may be generated between the second reference image 412 and the second calibration image 350, thereby determining the image region 1110 corresponding to the second calibration image 350 in the second reference image 412.

Referring to FIG. 11D, the obstacle avoidance image information may, for example, correspond to an obstacle avoidance image 1120.

In Step S950, the first processing unit 113 performs edge detection operation on the obstacle avoidance image information to generate edge detection result image information corresponding to an edge detection result image.

As shown in FIG. 11B to FIG. 11D, the difference between this embodiment and the first embodiment is that the obstacle avoidance image 1120 of this embodiment is generated by performing mapping transformation on the second reference image 1012, and the second reference image 1012 is generated by capturing the second calibration image 350, and the second calibration image 350 itself does not include the calibration pattern 311 as shown in FIG. 3A. The edge detection result image generated according to the obstacle avoidance image 1120 does not contain partial information corresponding to the calibration pattern 311. Accordingly, after the first processing unit 113 performs edge detection operation on the obstacle avoidance image information to generate edge detection result image information, there is no need to perform region masking to exclude pattern edges corresponding to the calibration pattern. In other words, after executing Step S950, the edge detection result image information generated by the first processing unit 113 is like the edge detection result image 460 that does not contain pattern edges of the calibration pattern as shown in FIG. 4G, and may be directly applied to the maximum obstacle-free region determination of subsequent Steps S960 to S970 (corresponding to Steps S260 to S270 of the first embodiment in FIG. 2).

In Step S960, the first processing unit 113 performs region determination operation on the edge detection result image information to set a maximum obstacle-free region in the edge detection result image 460. Specifically, in this embodiment, for the detailed means and principle of Step S960, reference may be made to the same detailed means and principle of Step S260 of First embodiment, so reference may be made to the description in FIG. 5A to FIG. 8, and thus details will not be repeated here.

In Step S970, the first processing unit 113 generates a plurality of projection range coordinates based on the maximum obstacle-free region, and sends the plurality of projection range coordinates to the projection device 120.

In this embodiment, for the details of Step S970, reference may be made to the related description of Step S270 in First embodiment, so details will not be repeated here.

In summary, in the disclosure, the first calibration image 310 containing the calibration pattern 311 is mainly used to enable the mobile device 110 to obtain matching image feature point pairs of the first reference image 410 and the first calibration image 310, thereby calculating a transformation matrix for mapping transformation. Furthermore, the main difference between the second embodiment and the first embodiment is that the projection device 120 of the second embodiment projects an additional full background color second calibration image 350, the mobile device 110 to directly obtain the second reference images 1011, 1012 that do not contain information related to the calibration pattern 311, thereby the method omitting region masking operation and directly applying to subsequent maximum obstacle-free region determination operation.

In summary, the obstacle avoidance projection method of the embodiments of the disclosure has at least one of the following advantages. (1) Achieving automatic obstacle identification: by capturing images through the camera unit of the mobile device and performing algorithm processing, the optimal projection range that can avoid obstacles may be automatically found to facilitate the projection device to execute calibration setting of the projection region. (2) Providing a convenient operation interface through the application program of the mobile device: without needing to gradually search for obstacle avoidance function settings in the projection device through a remote controller, users merely need to install an application program in a mobile device with photography function and communicate with the projection device through the application program to take photos of the projection image for setting. (3) Automatic calibration and projection region adjustment: users do not need to manually set the four corner coordinates of the image one by one to avoid obstacles, the system may automatically obtain the four corner coordinates of the projection region after obstacle avoidance through the algorithm of the mobile device application program, and provide such information to the projection device to complete calibration setting, thereby effectively reducing manual operation time. (4) Enhancing projection setup efficiency and accuracy: compared to the conventional method of manually adjusting four corner coordinates, the automatic obstacle avoidance mechanism described in the disclosure may quickly complete the setting of the maximum available projection range, significantly simplifying the setup process and improving overall accuracy.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An obstacle avoidance projection method executed by a mobile device, wherein the mobile device comprises a camera unit and a processing unit electrically coupled to the camera unit, the mobile device is communicatively connected to a projection device, and the obstacle avoidance projection method comprises steps of:
capturing a first reference image by the camera unit, wherein the first reference image comprises a first calibration image projected by the projection device onto a projection surface according to first calibration image information, and the first calibration image comprises a calibration pattern; and
executing steps as follows by the processing unit:
receiving first reference image information corresponding to the first reference image from the camera unit, and obtaining first calibration image information corresponding to the first calibration image;
calculating a plurality of matching image feature point pairs based on the first reference image information and the first calibration image information;
based on the plurality of matching image feature point pairs, performing mapping transformation on region information corresponding to the first calibration image in the first reference image information to generate obstacle avoidance image information;
performing an edge detection operation on the obstacle avoidance image information to generate edge detection result image information corresponding to an edge detection result image, and calibrating partial information corresponding to the calibration pattern in the edge detection result image information;
performing a region determination operation on the corrected edge detection result image information to set a maximum obstacle-free region in the edge detection result image, and
generating a plurality of projection range coordinates based on the maximum obstacle-free region, and sending the plurality of projection range coordinates to the projection device.

2. The obstacle avoidance projection method as claimed in claim 1, wherein the step of based on the plurality of matching image feature point pairs, performing mapping transformation on the region information corresponding to the first calibration image in the first reference image information to generate the obstacle avoidance image information further comprises steps as follows:
performing feature point detection and matching calculation based on the first reference image information and the first calibration image information to generate the plurality of matching image feature point pairs of the first reference image and the first calibration image;
generating a first transformation matrix based on the plurality of matching image feature point pairs, and performing inverse matrix operation on the first transformation matrix to generate a second transformation matrix;
using the first transformation matrix to map the first calibration image information to the first reference image information to determine the region information corresponding to the first calibration image in the first reference image information; and
using the second transformation matrix to map the region information to the obstacle avoidance image information.

3. The obstacle avoidance projection method as claimed in claim 1, wherein the step of calibrating the partial information corresponding to the calibration pattern in the edge detection result image information further comprises steps as follows:
obtaining first image region information of a first image region occupied by the calibration pattern in the obstacle avoidance image information;
determining second image region information corresponding to the first image region information in the edge detection result image information;
performing region mask coverage on the edge detection result image information according to the second image region information to exclude a pattern edge corresponding to the calibration pattern in the edge detection result image.

4. The obstacle avoidance projection method as claimed in claim 1, wherein the step of performing region determination operation on the corrected edge detection result image information to set the maximum obstacle-free region in the edge detection result image further comprises steps as follows:
(a) determining a candidate image region in the edge detection result image according to a preset dimension, wherein the preset dimension has a preset aspect ratio and is smaller than the corrected edge detection result image ;
(b) calculating a grayscale value of all pixels corresponding to the candidate image region in the corrected edge detection result image information, and determining whether the candidate image region satisfies a preset condition based on the grayscale value;
(c) in response to determining that the candidate image region satisfies the preset condition, setting the candidate image region that satisfies the preset condition as the maximum obstacle-free region;
(d) in response to determining that the candidate image region does not satisfy the preset condition, moving the candidate image region, and returning to the step (b).

5. The obstacle avoidance projection method as claimed in claim 4, wherein the step (a) of determining the candidate image region in the corrected edge detection result image according to the preset dimension further comprises steps as follows:
determining the candidate image region corresponding to a specified dimension at an initial position in the corrected edge detection result image ;
wherein the step (d) of in response to determining that the candidate image region does not satisfy the preset condition, moving the candidate image region comprises steps as follows:
moving the candidate image region along a first direction by a first movement distance; and
in response to the moved candidate image region exceeding the edge detection result image in the first direction, changing to move the candidate image region along a second direction by a second movement distance based on the initial position in the first direction.

6. The obstacle avoidance projection method as claimed in claim 4, wherein the step (b) of calculating the grayscale value of all the pixels corresponding to the candidate image region, and determining whether the candidate image region satisfies the preset condition based on the grayscale value further comprises:
determining whether the grayscale value is equal to a possible maximum value;
if yes, determining that the candidate image region satisfies the preset condition.

7. The obstacle avoidance projection method as claimed in claim 4, wherein the step (b) of calculating the grayscale value of all the pixels corresponding to the candidate image region in the edge detection result image information, and determining whether the candidate image region satisfies the preset condition based on the grayscale value further comprises steps as follows:
determining whether the grayscale value is greater than a preset threshold;
if yes, determining that the candidate image region satisfies the preset condition.

8. The obstacle avoidance projection method as claimed in claim 4, comprising:
calculating integral image information of the corrected edge detection result image information,
wherein the step (b) of calculating the grayscale value of all the pixels corresponding to the candidate image region, and determining whether the candidate image region satisfies the preset condition based on the grayscale value further comprises steps as follows:
calculating a sum of grayscale values or an average grayscale value of all the pixels corresponding to the candidate image region according to the integral image information, wherein the grayscale value is the sum of grayscale values or the average grayscale value.

9. The obstacle avoidance projection method as claimed in claim 4, further comprising steps as follows:
(e) in response to the moved candidate image region exceeding the edge detection result image in the second direction, reducing the preset dimension;
(f) in response to determining that the reduced preset dimension is not smaller than a minimum preset dimension, returning to the step (a); and
(g) in response to determining that the reduced preset dimension is less than the minimum preset dimension, determining that the edge detection result image does not contain the maximum obstacle-free region.

10. The obstacle avoidance projection method as claimed in claim 1, wherein the maximum obstacle-free region is a region defined by a plurality of corner coordinates in the edge detection result image, and the step of generating the projection range coordinates based on the maximum obstacle-free region further comprises:
obtaining a plurality of calibrated projection corner coordinates used when the projection device projects the first calibration image;
performing mapping transformation based on the corner coordinates and the calibrated projection corner coordinates to generate the projection range coordinates.

11. An obstacle avoidance projection method executed by a mobile device, wherein the mobile device comprises a camera unit and a processing unit coupled to the camera unit, the mobile device is communicatively connected to a projection device, and the obstacle avoidance projection method comprises steps of:
capturing a first reference image by the camera unit, wherein the first reference image comprises a first calibration image projected by the projection device onto a projection surface, and the first calibration image comprises a calibration pattern;
capturing a second reference image by the camera unit, wherein the second reference image comprises a second calibration image projected by the projection device onto the projection surface, and the second calibration image is a background color image; and
executing steps as follows by the processing unit:
receiving first reference image information corresponding to the first reference image and second reference image information corresponding to the second reference image from the camera unit, and obtaining first calibration image information corresponding to the first calibration image;
calculating a plurality of matching image feature point pairs based on the first reference image information and the first calibration image information;
based on the plurality of matching image feature point pairs, performing mapping transformation on region information corresponding to the first calibration image in the second reference image information to generate obstacle avoidance image information;
performing an edge detection operation on the obstacle avoidance image information to generate edge detection result image information corresponding to an edge detection result image;
performing a region determination operation on the edge detection result image information to set a maximum obstacle-free region in the edge detection result image; and
generating a plurality of projection range coordinates based on the maximum obstacle-free region, and sending the plurality of projection range coordinates to the projection device.

12. The obstacle avoidance projection method as claimed in claim 11, wherein the step of based on the plurality of matching image feature point pairs, performing mapping transformation on the region information corresponding to the first calibration image in the second reference image information to generate the obstacle avoidance image information comprises steps as follows:
performing feature point detection and matching calculation based on the first reference image information and the first calibration image information to generate the plurality of matching image feature point pairs of the first reference image and the first calibration image;
generating a first transformation matrix based on the plurality of matching image feature point pairs, and performing an inverse matrix operation on the first transformation matrix to generate a second transformation matrix;
using the first transformation matrix to map the first calibration image information to the second reference image information to determine region information corresponding to the second calibration image in the second reference image information; and
using the second transformation matrix to map the region information to the obstacle avoidance image information.

13. The obstacle avoidance projection method as claimed in claim 11, wherein the step of performing region determination operation on the edge detection result image information to determine the maximum obstacle-free region in the edge detection result image comprises steps as follows:
(a) determining a candidate image region in the edge detection result image according to a preset dimension, wherein the preset dimension has a preset aspect ratio;
(b) calculating a grayscale value of all pixels corresponding to the candidate image region in the edge detection result image information, and determining whether the candidate image region satisfies a preset condition based on the grayscale value;
(c) in response to determining that the candidate image region satisfies the preset condition, setting the candidate image region that satisfies the preset condition as the maximum obstacle-free region;
(d) in response to determining that the candidate image region does not satisfy the preset condition, moving the candidate image region, and returning to the step (b).

14. The obstacle avoidance projection method as claimed in claim 13, wherein the step (a) of determining the candidate image region in the edge detection result image according to the preset dimension further comprises steps as follows:
determining the candidate image region corresponding to the preset dimension at an initial position in the edge detection result image;
wherein the step (d) of in response to determining that the candidate image region does not satisfy the preset condition, moving the candidate image region further comprises steps as follows:
moving the candidate image region along a first direction by a first movement distance; and
in response to the moved candidate image region exceeding the edge detection result image in the first direction, changing to move the candidate image region along a second direction by a second movement distance based on the initial position in the first direction.

15. The obstacle avoidance projection method as claimed in claim 13, wherein the step (b) of calculating the grayscale value of all the pixels corresponding to the candidate image region in the edge detection result image information, and determining whether the candidate image region satisfies the preset condition based on the grayscale value further comprises:
determining whether the grayscale value is equal to a possible maximum value;
if yes, determining that the candidate image region satisfies the preset condition.

16. The obstacle avoidance projection method as claimed in claim 13, wherein the step (b) of calculating the grayscale value of all the pixels corresponding to the candidate image region in the edge detection result image information, and determining whether the candidate image region satisfies the preset condition based on the grayscale value further comprises:
determining whether the grayscale value is greater than a preset threshold;
if yes, determining that the candidate image region satisfies the preset condition.

17. The obstacle avoidance projection method as claimed in claim 13, comprising:
calculating integral image information of the edge detection result image information;
wherein the step (b) of calculating the grayscale value of all the pixels corresponding to the candidate image region, and determining whether the candidate image region satisfies the preset condition based on the grayscale value further comprises steps as follows:
calculating a sum of grayscale values or an average grayscale value of all the pixels corresponding to the candidate image region according to the integral image information, wherein the grayscale value is the sum of grayscale values or the average grayscale value.

18. The obstacle avoidance projection method as claimed in claim 13, further comprising steps as follows:
(e) in response to the moved candidate image region exceeding the edge detection result image in the second direction, reducing the preset dimension;
(f) in response to determining that the reduced preset dimension is not less than a minimum preset dimension, returning to the step (a); and
(g) in response to determining that the reduced preset dimension is less than the minimum preset dimension, determining that the edge detection result image does not contain the maximum obstacle-free region.

19. The obstacle avoidance projection method as claimed in claim 11, wherein the maximum obstacle-free region is a region defined by a plurality of corner coordinates in the edge detection result image, and the step of generating the projection range coordinates based on the maximum obstacle-free region further comprises steps as follows:
obtaining a plurality of calibrated projection corner coordinates used when the projection device projects the first calibration image;
performing mapping transformation based on the corner coordinates and the calibrated projection corner coordinates to generate the projection range coordinates.

20. A projection system, comprising:
a projection device configured to project a first calibration image onto a projection surface according to first calibration image information, wherein the first calibration image comprises a calibration pattern; and
a mobile device communicatively connected to the projection device and configured to execute the obstacle avoidance projection method as claimed in claim 1;
wherein the projection device sets a projection range according to a plurality of projection range coordinates.

21. The projection system as claimed in claim 20, wherein the mobile device comprises:
a camera unit configured to capture the first reference image;
a first storage unit configured to store a first application program and the first calibration image information of the first calibration image;
a first processing unit coupled to the camera unit and the first storage unit, configured to execute the first application program to execute the obstacle avoidance projection method;
a first communication unit coupled to the first processing unit, configured to send the projection range coordinates to the projection device;
a display unit coupled to the first processing unit, configured to display the captured first reference image or an operation interface of the first application program.

22. The projection system as claimed in claim 21, wherein the operation interface of the first application program comprises identity information of the projection device, and the first processing unit is configured to:
in response to determining that the identity information of the projection device is selected, control the first communication unit to establish a connection with the projection device;
in response to determining that an obstacle avoidance function in the operation interface of the first application program is activated, control the first communication unit to send an obstacle avoidance function activation instruction to the projection device through the connection.

23. The projection system as claimed in claim 20, wherein the projection device comprises:
a second communication unit configured to receive an obstacle avoidance function activation instruction;
a second storage unit configured to store a second application program and the first calibration image information of the first calibration image;
a second processing unit coupled to the second communication unit and the second storage unit, configured to execute the second application program in response to the obstacle avoidance function activation instruction, so as to read the first calibration image information from the second storage unit;
an image processing unit coupled to the second processing unit, configured to receive the first calibration image information from the second processing unit;
an illumination system configured to generate an illumination beam;
a light modulation module coupled to the image processing unit and the illumination system, and controlled by the image processing unit to convert the illumination beam into an image beam corresponding to the first calibration image based on the first calibration image information;
a projection lens coupled to the light modulation module, configured to project the image beam corresponding to the first calibration image.

24. The projection system as claimed in claim 23, wherein the second processing unit is further configured to:
execute image keystone calibration based on device posture information of the projection device to generate a plurality of calibrated projection corner coordinates;
control the second communication unit to send the calibrated projection corner coordinates to the mobile device; and
generate adjusted first calibration image information according to the calibrated projection corner coordinates, and send the adjusted first calibration image information to the image processing unit,
wherein the image processing unit is further configured to:
control the light modulation module to convert the illumination beam into an image beam corresponding to the adjusted first calibration image based on the adjusted first calibration image information,
wherein the projection lens is further configured to:
project the image beam corresponding to the adjusted first calibration image.

25. A projection system, comprising:
a projection device configured to project a first calibration image onto a projection surface according to first calibration image information, and project a second calibration image onto the projection surface according to second calibration image information, wherein the first calibration image comprises a calibration pattern, and the second calibration image is a background color image; and
a mobile device communicatively connected to the projection device and configured to execute the obstacle avoidance projection method as claimed in claim 11;
wherein the projection device sets a projection range according to a plurality of projection range coordinates.

26. The projection system as claimed in claim 25, wherein the mobile device comprises:
a camera unit configured to capture the first reference image, wherein the first reference image comprises a first calibration image projected by the projection device onto a projection surface according to first calibration image information, and the first calibration image comprises a calibration pattern;
a first storage unit configured to store an application program and the first calibration image information of the first calibration image;
a first processing unit coupled to the camera unit and the first storage unit, configured to execute the application program to execute the obstacle avoidance projection method;
a first communication unit coupled to the first processing unit, configured to send the projection range coordinates to the projection device;
a display unit coupled to the first processing unit, configured to display the captured first reference image or an operation interface of the application program.

27. The projection system as claimed in claim 26, wherein the operation interface of the application program comprises identity information of the projection device, and the first processing unit is configured to:
in response to determining that the identity information of the projection device is selected, control the first communication unit to establish a connection with the projection device;
in response to determining that an obstacle avoidance function in the operation interface of the application program is activated, control the first communication unit to send an obstacle avoidance function activation instruction to the projection device through the connection.

28. The projection system as claimed in claim 25, wherein the projection device comprises:
a second communication unit configured to receive an obstacle avoidance function activation instruction;
a second storage unit configured to store an application program and the first calibration image information of the first calibration image;
a second processing unit coupled to the second communication unit and the second storage unit, configured to execute the application program in response to the obstacle avoidance function activation instruction, so as to read the first calibration image information from the second storage unit;
an image processing unit coupled to the second processing unit, configured to receive the first calibration image information from the second processing unit;
a illumination system configured to generate an illumination beam;
a light modulation module coupled to the image processing unit and the illumination system, and controlled by the image processing unit to convert the illumination beam into an image beam corresponding to the first calibration image based on the first calibration image information;
a projection lens coupled to the light modulation module, configured to project the image beam corresponding to the first calibration image.

29. The projection system as claimed in claim 28, wherein the second processing unit is further configured to:
execute image keystone calibration based on a device posture of the projection device to generate a plurality of calibrated projection corner coordinates;
control the second communication unit to send the calibrated projection corner coordinates to the mobile device;
generate adjusted first calibration image information according to the calibrated projection corner coordinates, and send the adjusted first calibration image information to the image processing unit,
wherein the image processing unit is further configured to:
control the light modulation module to convert the illumination beam into an image beam corresponding to the adjusted first calibration image based on the adjusted first calibration image information;
wherein the projection lens is further configured to:
project the image beam corresponding to the adjusted first calibration image.
